(19) United States
(12) Patent Application Publication
(10) Pub. No.: US 2020/0067218 A1
(43) Pub. Date: Feb. 27, 2020

(54) TERMINAL ASSEMBLY AND ELECTRONIC APPARATUS

(71) Applicant: KYOCERA Corporation, Kyoto (JP)

(72) Inventors: Talchi KIM, Yokohama-shi (JP); Kenichi OZASA, Yokohama-shi (JP)

(73) Assignee: KYOCERA Corporation, Kyoto (JP)

(21) Appl. No.: 16/549,045

(22) Filed: Aug. 23, 2019

(30) Foreign Application Priority Data
Aug. 27, 2018 (JP) 2018-158363

(51) Int. Cl. H01R 12/71; H01R 13/518; H01R 13/629

(52) U.S. Cl. CPC H01R 12/716; H01R 2201/16; H01R 13/62927; H01R 13/518

(57) ABSTRACT

A terminal assembly is connected to a mating connector at a receptacle formed in a housing of an electronic apparatus. The terminal assembly includes at least one terminal extending in a longitudinal direction, an insulating member, and a reinforcing member. The insulating member includes a holder holding at least one terminal, and a housing mounting portion extending from the holder in a direction transverse to the longitudinal direction, and fixed to the housing inside the housing. The reinforcing member includes a mounting reinforcing portion reinforcing the housing mounting portion.

### CROSS-REFERENCE TO RELATED APPLICATION

The present application claims priority under 35 U.S.C. § 119 to Japanese Patent Application No. 2018-158363, filed on Aug. 27, 2018, entitled “TERMINAL ASSEMBLY AND ELECTRONIC APPARATUS”. The content of which is incorporated by reference herein in its entirety.

### FIELD

Embodiments of the present disclosure relate generally to terminal assemblies and electronic apparatuses.

### BACKGROUND

As disclosed in Japanese Patent Application Laid-Open No. 2002-110299, an electronic apparatus having a receptacle for a connector has been known. A terminal assembly to be connected to an external connector is disposed inside the receptacle.

### SUMMARY

A terminal assembly is disclosed. In one embodiment, the terminal assembly is connected to a mating connector at a receptacle formed in a housing of an electronic apparatus. The terminal assembly includes at least one terminal extending in a longitudinal direction, an insulating member, and a reinforcing member. The insulating member includes a holder holding at least one terminal, and a housing mounting portion extending from the holder in a direction transverse to the longitudinal direction, and fixed to the housing inside the housing. The reinforcing member includes a mounting reinforcing portion reinforcing the housing mounting portion.

### BRIEF DESCRIPTION OF THE DRAWINGS

FIG. 1 illustrates a perspective view schematically illustrating one example of an external appearance of an electronic apparatus;

FIG. 2 illustrates a side view schematically illustrating one example of the external appearance of the electronic apparatus;

FIG. 3 illustrates a sectional view schematically illustrating one example of a configuration of a portion of the electronic apparatus;

FIG. 4 illustrates a sectional view schematically illustrating one example of a configuration of a portion of the electronic apparatus;

FIG. 5 illustrates a perspective view schematically illustrating one example of a configuration of a portion of the electronic apparatus;

FIG. 6 illustrates an exploded perspective view schematically illustrating one example of a configuration of a portion of a terminal assembly;

FIG. 7 illustrates a perspective view schematically illustrating one example of a configuration of a portion of the electronic apparatus;

FIG. 8 illustrates a perspective view schematically illustrating one example of a configuration of a locking structure;

FIG. 9 illustrates a perspective view schematically illustrating one example of a configuration of a portion of the electronic apparatus;

FIG. 10 illustrates a perspective view schematically illustrating one example of a configuration of a terminal assembly and a portion of a circuit board;

FIG. 11 illustrates a perspective view schematically illustrating one example of a configuration of a portion of the electronic apparatus;

FIG. 12 illustrates a side view schematically illustrating one example of a configuration of a portion of the electronic apparatus; and

FIG. 13 illustrates a perspective view schematically illustrating one example of a configuration of a portion of the electronic apparatus.

### DETAILED DESCRIPTION

### First Embodiment

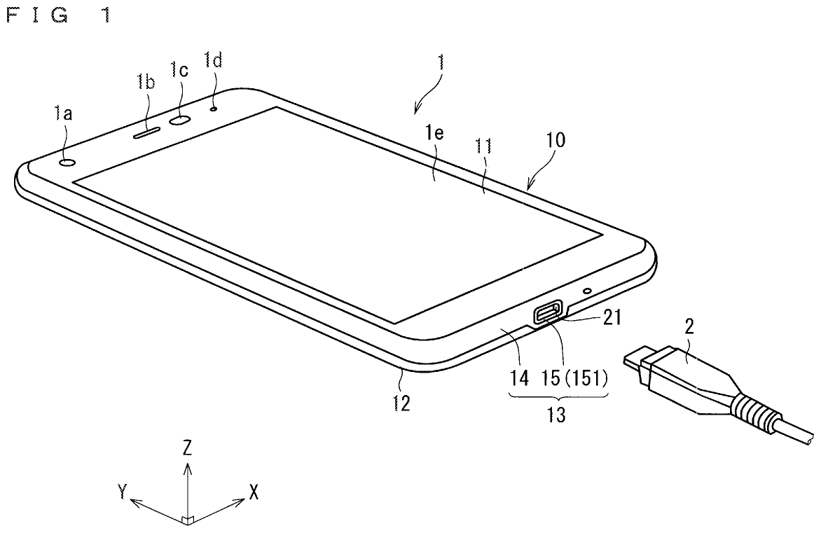

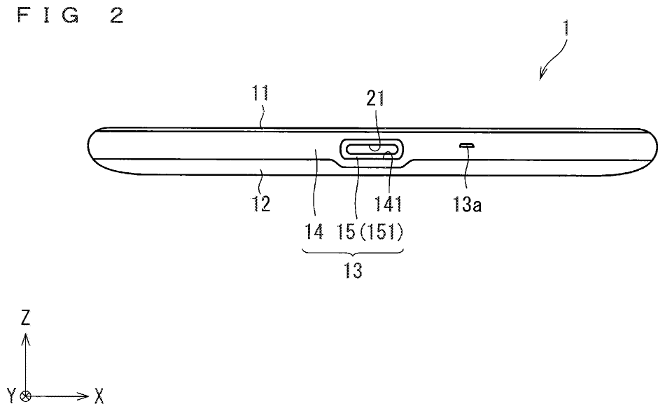

FIG. 1 is a perspective view schematically illustrating one example of an external appearance of an electronic apparatus 1. FIG. 2 is a side view schematically illustrating one example of the external appearance of the electronic apparatus 1. As illustrated in FIGS. 1 and 2, the electronic apparatus 1 may have a plate-like shape. The electronic apparatus 1 may be substantially rectangular as viewed along a thickness direction thereof. A transverse direction, a longitudinal direction, and a thickness direction of the electronic apparatus 1 are hereinafter respectively defined as an X-axis direction, a Y-axis direction, and a Z-axis direction. One side of the X-axis direction and the other side of the X-axis direction are hereinafter respectively referred to as a +X side and a −X side. The same applies to the Y axis and the Z axis.

The electronic apparatus 1 is, for example, a smartphone. The electronic apparatus 1, however, is not limited to the smartphone. For example, the electronic apparatus 1 may be a tablet terminal, a mobile phone, a phablet, a tablet personal computer (PC), a feature phone, a personal digital assistant (PDA), a remote control terminal, a portable music player, a gaming console, an e-book reader, or the like.

The electronic apparatus 1 can electrically be connected to another apparatus through a connector 2. For example, the electronic apparatus 1 can electrically be connected to an external power supply through the connector 2. A battery, which is not illustrated, of the electronic apparatus 1 can be charged by power supplied from the external power supply. The electronic apparatus 1 may be connected to an external apparatus through the connector 2, and communicate with the external apparatus through the connector 2.

The electronic apparatus 1 includes a housing 10. The housing 10 includes, for example, a front panel 11, a back cover 12, and an intermediate housing 13. The front panel 11 and the back cover 12 each have a substantially plate-like shape, and can be disposed to face each other in the Z-axis direction. The front panel 11 is located on a +Z side, and the back cover 12 is located on a −Z side. The front panel 11 and the back cover 12 can be disposed to each have a thickness direction along the Z-axis direction.

For example, glass, a synthetic resin, and other materials can be used as a material for the front panel 11. At least portion of the front panel 11 may be transparent. A display 1e may be located on the −Z side of the at least portion of the front panel 11. The display 1e is, for example, a display such as a liquid crystal display and an organic electro luminescence (EL) display. Display on the display 1e is controlled by a controller, which is not illustrated, of the electronic apparatus 1. Light from the display 1e passes through the at least portion of the front panel 11. This enables a user to visually identify an image displayed on the display 1e. The display 1e may be a touch screen display. The touch screen display detects contact or approaching of an operator, such as a finger and a stylus pen, and specifies the location thereof.

As illustrated in FIG. 1, an in-camera 1a, a receiver 1b, a proximity sensor 1c, and a lamp 1d may be disposed in the front panel 11. The in-camera 1a captures an image of an object facing the front panel 11. The in-camera 1a may be a digital camera. The in-camera 1a outputs data of the captured image to the controller of the electronic apparatus 1. The receiver 1b converts a sound signal transmitted from the controller of the electronic apparatus 1 into sound, and outputs the sound. For example, the receiver 1b can output voice on the other end of the line during a call. The proximity sensor 1c detects the presence of a nearby object in a noncontact manner, and outputs an electrical signal indicating the results of detection to the controller of the electronic apparatus 1. For example, the proximity sensor 1c detects a face of a user during a call as the nearby object. When the proximity sensor 1c detects the presence of the nearby object, the controller of the electronic apparatus 1 turns off display on the display 1e. Illumination of the lamp 1d is controlled by the controller of the electronic apparatus 1. The controller of the electronic apparatus 1 illuminates the lamp 1d, for example, at reception of a call. The lamp 1d may include a light emitting diode (LED).

For example, a synthetic resin, metal, and other materials can be used as a material for the back cover 12. An out-camera, which is not illustrated, and the like may be disposed in the back cover 12. The out-camera may be a digital camera, and captures an image of an object facing the back cover 12. The out-camera outputs data of the captured image to the controller of the electronic apparatus 1.

The intermediate housing 13 is located between the front panel 11 and the back cover 12. The intermediate housing 13 can form a side surface of the housing 10. For example, a synthetic resin, metal, and other materials can be used as a material for the intermediate housing 13. The side surface of the housing 10 (i.e., the intermediate housing 13) may have a receptacle (an insertion opening) 21 for the connector 2. As illustrated in FIG. 1, the receptacle 21 can be formed in a side surface of the housing 10 on a −Y side. A leading end of the connector 2 is inserted into the receptacle 21 along the Y-axis direction. That is to say, a direction in which the connector 2 is inserted and removed is the Y-axis direction.

As illustrated in FIG. 2, the side surface of the housing 10 may have a microphone hole 13a. A microphone is disposed inside the microphone hole 13a, and collects user's voice and sound around it. The microphone converts the collected sound into an electrical signal, and outputs the electrical signal to the controller of the electronic apparatus 1.

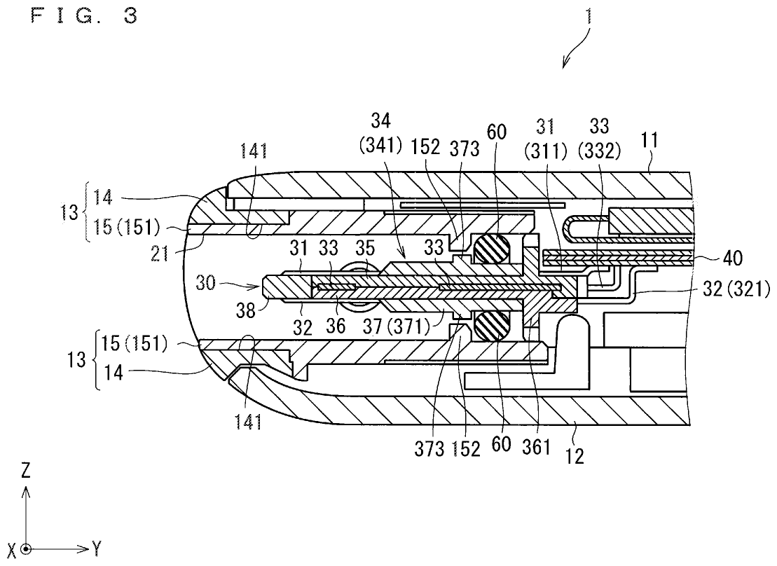

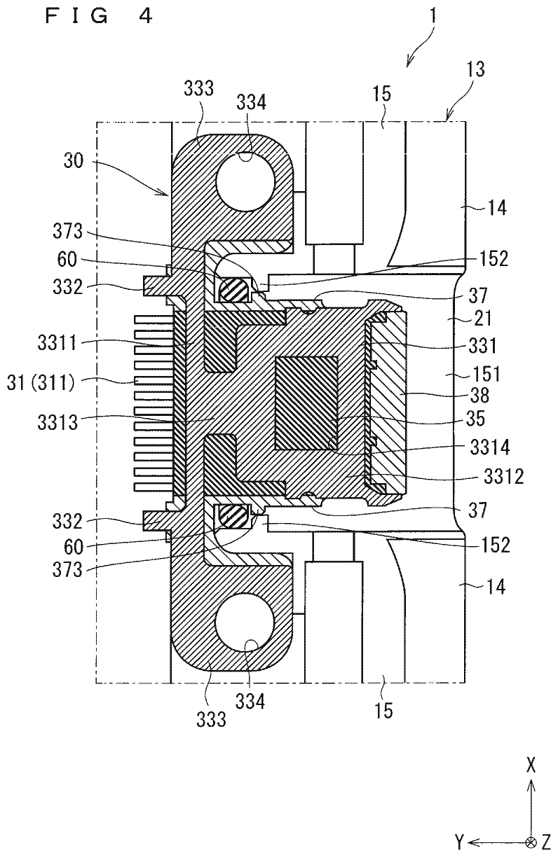

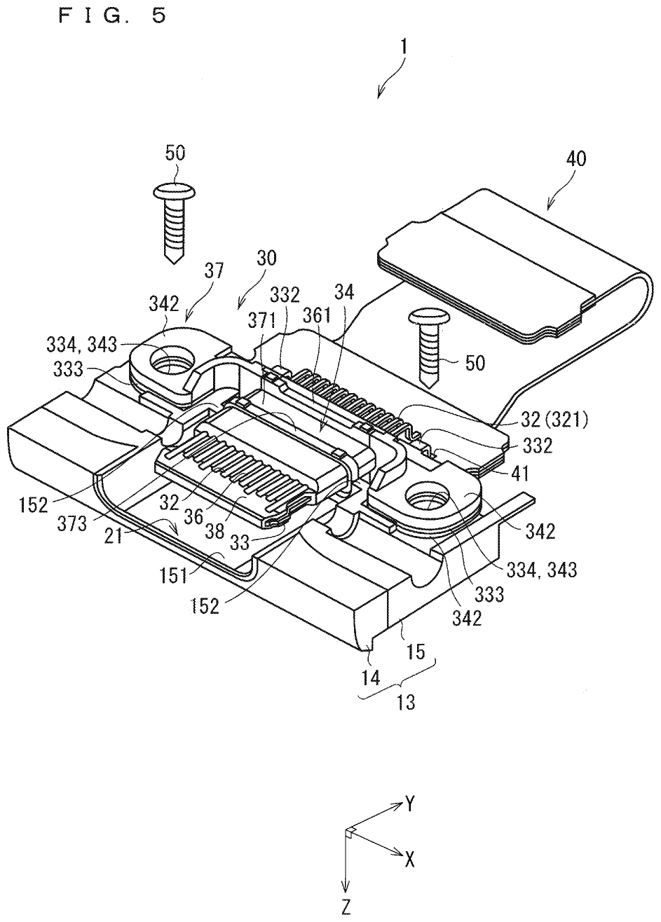

FIGS. 3 and 4 are each a sectional view schematically illustrating one example of a configuration of a portion of the electronic apparatus 1. FIG. 3 illustrates one example of a configuration inside the receptacle 21 in cross section parallel to a YZ plane. FIG. 4 illustrates one example of the configuration inside the receptacle 21 in cross section parallel to an XY plane. FIG. 5 is a perspective view schematically illustrating one example of a configuration of a portion of the electronic apparatus, and, specifically, illustrates a perspective view of the configuration illustrated in FIG. 4.

As illustrated in FIGS. 1 to 5, the intermediate housing 13 includes a frame-like member 14 and an inner member 15. The frame-like member 14 has a frame-like shape, and can form the side surface of the housing 10. At least portion of the frame-like member 14 can be made of metal, such as aluminium. Referring to FIG. 2, a side surface of the frame-like member 14 on the −Y side (i.e., the side surface of the housing 10 on the −Y side) has a through hole 141 at a location corresponding to the receptacle 21. The through hole 141 penetrates the frame-like member 14 along the Y-axis direction. The electronic apparatus 1 may be formed of the front panel 11 and the back cover 12 without including the intermediate housing. In this case, at least one of the front panel 11 and the back cover 12 may include a portion corresponding to at least one of the frame-like member 14 and the inner member 15.

The inner member 15 is located mainly inside the frame-like member 14 in plan view (i.e., as viewed along the Z-axis direction), and is coupled to the frame-like member 14. The inner member 15 can be made of a synthetic resin, such as a polycarbonate resin and a polyurethane resin. The frame-like member 14 and the inner member 15 may be formed integrally, for example, by insert molding. The inner member 15 can fix various components located inside the electronic apparatus 1. For example, the inner member 15 can function as a member fixing a terminal assembly 30, which will be described later.

The inner member 15 has a guide portion 151 forming the receptacle 21. A leading end of the guide portion 151 on the −Y side is tubular along an inner surface of the through hole 141 of the frame-like member 14. An inner peripheral surface of the guide portion 151 defines the receptacle 21. A space into which the leading end of the connector 2 is inserted along the Y-axis direction is thereby formed inside the guide portion 151. The inner peripheral surface of the guide portion 151 comes into contact with an outer peripheral surface of the leading end of the connector 2, and guides the leading end of the connector 2 along the Y-axis direction. As the guide portion 151, which is made of resin, forms the receptacle 21, and guides the connector 2 as described above, the electronic apparatus 1 is not required to include a metal shell (a member forming the receptacle 21, and guiding the connector 2) in this connector structure. Manufacturing costs can thereby be reduced.

The guide portion 151, which is made of resin, has lower stiffness (e.g., shear stiffness) than the metal shell. The leading end of the connector 2 is thus less likely to be worn away by a collision between the leading end of the connector 2 and the end of the guide portion 151 on the −Y side at insertion of the connector 2. That is to say, the leading end of the connector 2 can be protected.

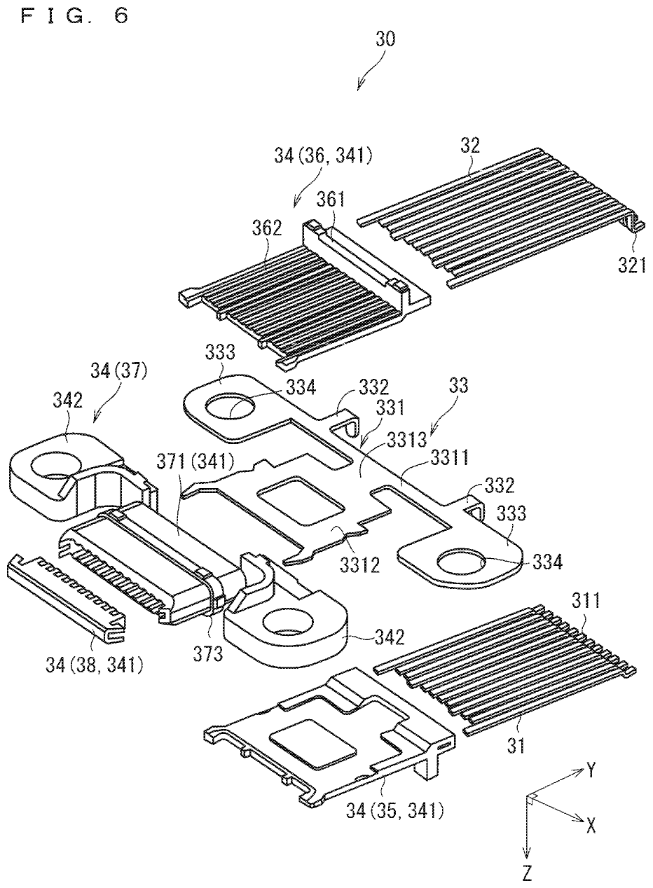

The terminal assembly 30 is located inside the guide portion 151. FIG. 6 is an exploded perspective view schematically illustrating one example of a configuration of the terminal assembly 30. The terminal assembly 30 is an assembly to be electrically connected to the connector 2. From the standpoint of the terminal assembly 30, the connector 2 can be said to be a mating connector. A pair of the guide portion 151 and the terminal assembly 30 can form a receptacle connector. The connector may be formed in conformity with a predetermined standard. The predetermined standard may include the universal serious bus (USB) standard and the Lightning® standard. The USB standard may include mini-USB, micro-USB, and USB Type-C. Mini-USB may include USB Type-A and USB Type-B. Micro-USB may include USB Type-A and USB Type-B.

The terminal assembly 30 includes a plurality of terminals 31, a plurality of terminals 32, a reinforcing member 33, and an insulating member 34. They can be formed integrally, for example, by insert molding.

The terminals 32 each have an elongated shape extending along the longitudinal direction (herein, the Y-axis direction). As a specific example, each of the terminals 32 has an elongated plate-like shape. The terminals 32 are disposed to each have a thickness direction along the Z-axis direction. The terminals 32 are arranged side by side with spaces therebetween in the X-axis direction. That is to say, the terminals 32 are arranged substantially in parallel with one another. Each of the terminals 32 has conductivity, and can be made of metal, such as aluminium.

As with the terminals 32, the terminals 31 each have an elongated shape extending along the Y-axis direction, and are arranged side by side with spaces therebetween in the X-axis direction. Each of the terminals 31 also has conductivity, and can be made of metal, such as aluminium. A group of the terminals 31 is located on the +Z side of a group of the terminals 32.

The insulating member 34 includes a holder 341 holding the terminals 31 and 32, and housing mounting portions 342 extending from opposite sides of the holder 341 in the X-axis direction, and fixed to the housing 10 (herein, the intermediate housing 13). For example, an insulating synthetic resin (e.g., resin such as polyamide, polyurethane, an epoxy-based resin, a polycarbonate resin, and a polyurethane resin) can be used as a material for the insulating member 34.

The insulating member 34 will be described below by being divided into four sub-members: an insulating member 35; an insulating member 36; an insulating member 37; and an insulating member 38.

Referring to FIG. 6, the insulating member 36 has a substantially plate-like shape, and is disposed to have a thickness direction along the Z-axis direction. The insulating member 36 may be substantially rectangular in plan view. A plurality of grooves extending along the Y-axis direction may have been formed in a region 362 on the −Y side of a surface of the insulating member 36 on the −Z side. The terminals 32 may be fitted in the respective grooves.

The insulating member 36 may have, on a +Y side of the region 362, a protrusion 361 protruding farther than the region 362 to the −Z side. As illustrated in FIG. 6, the protrusion 361 may extend from one end to the other end of the insulating member 36 along the X-axis direction. The protrusion 361 has a plurality of through holes communicating with the grooves in the region 362 and penetrating the protrusion 361 in the Y-axis direction. The terminals 32 pass through the respective through holes. That is to say, portions of the terminals 32 in the longitudinal direction are surrounded by the protrusion 361.

Respective ends 321 of the terminals 32 on the +Y side protrude farther than the insulating member 34 to the +Y side, and are connected to a circuit board 40 (see also FIG. 5). The circuit board 40 is located inside the housing 10 of the electronic apparatus 1, and may be a printed wiring board, for example. The ends 321 of the terminals 32 can be connected to a connection pad, which is not illustrated, on a surface of the circuit board 40 on the −Z side, for example, using a fixative, such as solder and a conductive adhesive. The terminals 32 are thereby electrically connected to the circuit board 40. Use of the solder as the fixative enables firmer connection of the terminals 32 to the circuit board 40.

The ends 321 of the terminals 32 may be bent substantially in a stepped manner to be close to the circuit board 40. More specifically, the ends 321 may be bent to the +Z side (to a side of the circuit board 40) to extend towards the circuit board 40, and bent, on the surface of the circuit board 40 on the −Z side, to the +Y side to extend along the circuit board 40. The ends 321 of the terminals 32 can be connected to the circuit board 40 in this portion extending along the circuit board 40.

The insulating member 35 has a substantially plate-like shape, and is disposed to have a thickness direction along the Z-axis direction (see FIG. 6). The insulating member 35 is located on the +Z side of the insulating member 36. The insulating member 35 faces the insulating member 36 in the Z-axis direction. The insulating member 35 has a similar shape to the insulating member 36. The insulating member 35, however, is in a reversed position of the insulating member 36 in the Z-axis direction.

The terminals 31 are located in a region on the −Y side of a surface of the insulating member 35 on the +Z side. The terminals 31 are disposed on the insulating member 35 in a similar manner to the terminals 32.

Respective ends 311 of the terminals 31 on the +Y side protrude farther than the insulating member 34 to the +Y side, and are connected to the circuit board 40. The ends 311 of the terminals 31 can be connected to the connection pad, which is not illustrated, on the surface of the circuit board 40 on the −Z side, for example, using the fixative, such as the solder and the conductive adhesive. The terminals 31 are thereby electrically connected to the circuit board 40. As with the ends 321 of the terminals 32, the ends 311 of the terminals 31 may be bent substantially in a stepped manner to be close to the circuit board 40. The ends 311 of the terminals 31 can be connected to the circuit board 40 in the portion extending along the circuit board 40.

A portion of the reinforcing member 33 is located between the insulating members 35 and 36. The reinforcing member 33 may have a plate-like shape. The reinforcing member 33 can be disposed to have a thickness direction along the Z-axis direction. The reinforcing member 33 can be set to have higher strength (e.g., flexural strength and tensile strength) than the insulating member 34. The reinforcing member 33 can also be set to have higher stiffness (e.g., flexural stiffness and shear stiffness) than the insulating member 34. This can improve stiffness of the terminal assembly 30 as a whole. Deformation of the terminal assembly 30 can thus be suppressed. For example, metal (e.g., a copper alloy and stainless steel), a synthetic resin (e.g., super-engineering plastic), ceramic, and other materials can be used as a material for the reinforcing member 33 as described above.

The insulating member 35 is located on a surface of the reinforcing member 33 on the +Z side. In other words, a portion of the insulating member 34 (specifically, the insulating member 35) is interposed between the terminals 31 and the reinforcing member 33. According to this configuration, each of the terminals 31 and the reinforcing member 33 are insulated from each other even if the reinforcing member 33 has conductivity. Similarly, the insulating member 36 is located on a surface of the reinforcing member 33 on the −Z side. In other words, a portion of the insulating member 34 (specifically, the insulating member 36) is interposed between the terminals 32 and the reinforcing member 33. According to this configuration, each of the terminals 32 and the reinforcing member 33 are insulated from each other even if the reinforcing member 33 has conductivity.

The reinforcing member 33 may include a main plate portion 331, a pair of board mounting portions 332, and a pair of mounting reinforcing portions 333. The insulating member 36 is located on a surface of the main plate portion 331 on the −Z side, and the insulating member 35 is located on a surface of the main plate portion 331 on the +Z side. That is to say, the main plate portion 331 is covered with the insulating members 35 and 36 from opposite sides.

As illustrated in FIG. 4, the insulating member 35 has regions not overlapping the reinforcing member 33 in the Z-axis direction. For example, the main plate portion 331 may include: a first portion (an extending portion) 3311 extending along the X-axis direction on the +Y side; a second portion 3312 having a substantially rectangular outline on the −Y side of the first portion 3311; and a third portion 3313 connecting the first portion 3311 and the second portion 3312. The width in the X-axis direction of the third portion 3313 is smaller than that of each of the first portion 3311 and the second portion 3312. According to the main plate portion 331 as described above, there can be a space between the first portion 3311 and the second portion 3312 in plan view. The insulating member 35 is present in the space, and is not opposite the reinforcing member 33 in the Z-axis direction in the region. As illustrated in FIG. 4, the second portion 3312 of the main plate portion 331 may have a through hole 3314 penetrating the second portion 3312 in the Z-axis direction. The insulating member 35 is present in a region opposite the through hole 3314, and is not opposite the reinforcing member 33 in the region. The insulating member 35 sticks out of the reinforcing member 33 both to the +Y side and the −Y side, and is not opposite the reinforcing member 33 in these regions.

The insulating member 36 has a similar shape to the insulating member 35. The insulating members 35 and 36 can be sealingly coupled to each other in regions not opposite the reinforcing member 33. In other words, the main plate portion 331 is partially covered with the insulating member 34.

The reinforcing member 33 also has portions exposed from the insulating members 35 and 36. For example, opposite ends of the first portion 3311 of the reinforcing member 33 in the X-axis direction protrude from the insulating members 35 and 36 to opposite sides. The pair of board mounting portions 332 of the reinforcing member 33 also protrudes from the first portion 3311 to the +Y side. These board mounting portions 332 are also exposed from the insulating members 35 and 36 (further, from the insulating member 34).

The board mounting portions 332 are located with a space therebetween in the X-axis direction, and are located opposite each other with respect to a group of the ends 311 of the terminals 31 In other words, the ends 311 of the terminals 31 are located between the board mounting portions 332. The terminals 32 are disposed in a region similar to a region in which the terminals 31 are disposed in plan view. The ends 321 of the terminals 32 are thus located between the board mounting portions 332.

The pair of board mounting portions 332 is fixed to the circuit board 40. As illustrated in FIG. 5, for example, the board mounting portions 332 may be bent towards the circuit board 40, and inserted into a hole 41 formed in the circuit board 40. The hole 41 may be a recess located in a surface of the circuit board 40 on the −Z side, or may penetrate the circuit board 40 in the thickness direction (Z-axis direction). In a case where the hole 41 penetrates the circuit board 40, the board mounting portions 332 may pass through the hole 41. In a state of being inserted in the hole 41 of the circuit board 40, the board mounting portions 332 can be fixed to the circuit board 40 using the fixative, such as the adhesive and the solder, at the location of insertion.

As described above, according to the electronic apparatus 1, the terminal assembly 30 is fixed to the circuit board 40 by the board mounting portions 332 having higher stiffness. Thus, the terminal assembly 30 can more firmly be fixed to the circuit board 40. Even if an external force is applied to the terminal assembly 30 and the circuit board 40, distortion is less likely to occur at points of contact between the terminals 31 and the circuit board 40 and at points of contact between the terminals 32 and the circuit board 40. Signal transmission through the terminals 31 and signal transmission through the terminals 32 can thereby be stabilized.

In the above-mentioned example, the board mounting portions 332 are inserted into the hole 41 of the circuit board 40. Due to an increase in area of contact with the fixative at the location of insertion, the board mounting portions 332 can more firmly be fixed to the circuit board 40. If the board mounting portions 332 pass through the hole 41, the board mounting portions 332 can more firmly be fixed to the circuit board 40 due to a further increase in area of contact.

On the other hand, if the board mounting portions 332 do not pass through the hole 41, leading ends of the board mounting portions 332 do not protrude from the circuit board 40 to the +Z side, and thus a space on the +Z side of the circuit board 40 can be used effectively.

In the above-mentioned example, the board mounting portions 332 are located opposite each other with respect to the ends 311 of the terminals 31 and the ends 321 of the terminals 32 in a direction (herein, the X-axis direction) transverse to the longitudinal directions of the terminals 31 and the terminals 32. That is to say, the board mounting portions 332 protrude from the first portion 3311 along the Y-axis direction, and are fixed to the circuit board 40 on opposite sides with respect to the ends 311 and the ends 321. In other words, the board mounting portions 332 are not present between any two ends of the ends 311 and any two ends of the ends 321 in the X-axis direction. According to this configuration, physical interference of the board mounting portions 332 with each of the ends 311 of the terminals 31 and the ends 321 of the terminals 32 is easily avoided.

Prior to description of the pair of mounting reinforcing portions 333 of the reinforcing member 33, the insulating member 37 will be described next. The insulating member 37 includes a terminal protecting portion 371 and the housing mounting portions 342 (see also FIG. 6). The terminal protecting portion 371 may externally and partially cover the terminals 31 and 32. For example, the terminal protecting portion 371 may externally cover the terminals 31 and 32 except for three portions described below. First, a portion of the terminals 32 covered with the protrusion 361 of the insulating member 36 is not covered with the terminal protecting portion 371. This is because the portion is already protected, and is not required to be covered with the terminal protecting portion 371. The same applies to a portion of the terminals 31 covered with the insulating member 35.

Second, the ends 311 of the terminals 31 and the ends 321 of the terminals 32 are not covered with the terminal protecting portion 371. This is because the ends 311 and 321 are exposed from the insulating member 34, and connected to the circuit board 40.

Third, portions of the terminals 31 and 32 on the −Y side are not covered with the terminal protecting portion 371. This is because the exposed portions of the terminals 31 and 32 on the −Y side function as contacts coming into contact with a terminal of the connector 2.

In the example of FIG. 5, leading ends of the terminals 32 on the −Y side protrude from the insulating member 35 to the −Y side, and are disposed over a surface of the insulating member 38 on the −Z side. Similarly, leading ends of the terminals 31 on the −Y side protrude from the insulating member 36 to the −Y side, and are disposed over a surface of the insulating member 38 on the +Z side. The surfaces of the insulating member 38 on the +Z side and on the −Z side may have grooves in which the terminals 31 and 32 are fitted. The insulating member 38 is a leading end portion of the terminal assembly 30 on the −Y side.

The holder 341 of the insulating member 34 holding the terminals 31 and 32 is formed by the insulating member 35, the insulating member 36, the terminal protecting portion 371 of the insulating member 37, and the insulating member 38.

A protrusion (second protrusion) 373 may be located on an outer peripheral surface of the terminal protecting portion 371. The protrusion 373 protrudes to the outside (the side of the guide portion 151) of the terminal protecting portion 371. The protrusion 373 may be located over the entire periphery of the terminal protecting portion 371, for example.

A protrusion (first protrusion) 152 may be located on the guide portion 151 at a location opposite the protrusion 373. The protrusion 152 protrudes from the inner peripheral surface to the inside of the guide portion 151 (the side of the terminal assembly 30). The protrusion 152 may be located over the entire periphery of the inner peripheral surface of the guide portion 151.

As illustrated in FIG. 3, an end surface of the protrusion 152 of the guide portion 151 on the −Y side (i.e., the end surface on an entrance side of the receptacle 21) may be located on the −Y side with respect to an end surface of the protrusion 373 of the insulating member 37 on the −Y side. According to this configuration, at insertion of the connector 2, the leading end of the connector 2 comes into contact with the protrusion 152 of the guide portion 151 without coming into contact with the protrusion 373 of the insulating member 37. That is to say, the protrusion 152 functions as a stopper for the connector 2. According to this configuration, at insertion of the connector 2, a force to the +Y side is transmitted to the protrusion 152 of the guide portion 151, but is less likely to be transmitted to the protrusion 373 of the terminal assembly 30. Distortion is thus less likely to occur at the points of contact between the terminals 31 and the circuit board 40 and at the points of contact between the terminals 32 and the circuit board 40. Signal transmission through the terminals 31 and signal transmission through the terminals 32 can thereby be stabilized.

As the protrusion 373 is located on the terminal assembly 30, the protrusion 373 of the terminal assembly 30 can function as the stopper even if the protrusion 152 is damaged to no longer function as the stopper.

As illustrated in FIG. 4, a sealing member 60 may be located. The sealing member 60 is located, on the +Y side of the protrusions 152 and 373, between the inner peripheral surface of the guide portion 151 and the outer peripheral surface of the terminal protecting portion 371. The sealing member 60 is an o-ring, for example, and seals a space between the terminal assembly 30 and the guide portion 151.

The pair of housing mounting portions 342 of the insulating member 37 will be described next. The housing mounting portions 342 extend from the terminal protecting portion 371 of the insulating member 37 to opposite sides in the X-axis direction. More specifically, the housing mounting portions 342 extend from portions of the terminal protecting portion 371 on the +Y side of the protrusion 373 to the opposite sides in the X-axis direction.

The housing mounting portions 342 are opposite the mounting reinforcing portions 333 of the reinforcing member 33 in the Z-axis direction. Referring also to FIG. 4, for example, the mounting reinforcing portions 333 of the reinforcing member 33 extend from the opposite ends of the first portion 3311 in the X-axis direction to the opposite sides. One of the housing mounting portions 342 on the +X side may cover one of the mounting reinforcing portions 333 on the +X side. Specifically, one of the housing mounting portions 342 on the +X side may cover a surface on the +Z side and a surface on the −Z side of one of the mounting reinforcing portions 333 on the +X side. Similarly, the other one of the housing mounting portions 342 on the −X side may cover the other one of the mounting reinforcing portions 333 on the −X side. The mounting reinforcing portions 333 have higher stiffness than the housing mounting portions 342, and thus substantially reinforce the housing mounting portions 342.

The housing mounting portions 342 and the mounting reinforcing portions 333 each may have a substantially rectangular outline, for example, in plan view.

The holder 341 is located inside the guide portion 151 of the inner member 15 of the intermediate housing 13, and the housing mounting portions 342 are located on opposite sides in the X-axis direction on the outside of the guide portion 151. The housing mounting portions 342 are opposite the housing 10 (herein, the inner member 15 of the intermediate housing 13; the same applies to the following) in the Z-axis direction, and are fixed to the inner member 15.

For example, the housing mounting portions 342 and the mounting reinforcing portions 333 may respectively have mounting holes 343 and mounting holes 334 for fastening. The mounting holes 343 and the mounting holes 334 communicate with each other in the Z-axis direction, and the mounting holes 343 and 334 as a whole penetrate the housing mounting portions 342 and the mounting reinforcing portion 333 in the Z-axis direction. The mounting holes 343 and the mounting holes 334 are each a hole for fastening.

On the other hand, the inner member 15 may have fastening holes (e.g., threaded holes) in regions overlapping the mounting holes 343 and 334 in the Z-axis direction. Fastening members (e.g., screws) 50 may pass through the mounting holes 343 and 334, and be combined (e.g., screwed) with the fastening holes formed in the inner member 15. The terminal assembly 30 can thereby be fixed to the inner member 15 and by extension to the housing 10.

As described above, according to the terminal assembly 30, the reinforcing member 33 includes the mounting reinforcing portions 333. Stiffness of portions (portions including the housing mounting portions 342 and the mounting reinforcing portions 333) of the terminal assembly 30 fixed to the housing 10 can thereby be improved. Thus, the terminal assembly 30 can more firmly be fixed to the housing 10. As the terminal assembly 30 can be firmly fixed to the housing 10, displacement of the terminal assembly 30 at insertion and removal of the connector 2 can be reduced, for example. According to this configuration, distortion at the points of contact between the terminals 31 and the circuit board 40 and at the points of contact between the terminals 32 and the circuit board 40 can be reduced. Signal transmission through the terminals 31 and signal transmission through the terminals 32 can thereby be stabilized.

In the above-mentioned example, the main plate portion 331 of the reinforcing member 33 is opposite the terminals 31 and 32 in the Z-axis direction. The main plate portion 331 can thereby reinforce the leading end portion of the terminal assembly 30 to be connected to the connector 2. This can reduce the possibility of deformation of the leading end portion of the terminal assembly 30 even if a force acts on the leading end portion of the terminal assembly 30 from the connector 2 at insertion of the connector 2. In other words, the reliability of the connector structure of the electronic apparatus 1 can be improved.

Although the pair of board mounting portions 332 is located in the above-mentioned example, it is only required that at least one board mounting portion 332 be located. Similarly, although the pair of housing mounting portions 342 and the pair of mounting reinforcing portions 333 corresponding to the pair of housing mounting portions 342 are located in the above-mentioned example, it is only required that at least one housing mounting portion 342 and at least one mounting reinforcing portion 333 corresponding to at least one housing mounting portion 342 be located.

In the above-mentioned example, the reinforcing member 33 includes both the board mounting portions 332 and the mounting reinforcing portions 333. In terms of firmly fixing the terminal assembly 30 to the housing 10, however, the reinforcing member 33 is only required to include the mounting reinforcing portions 333, and may not necessarily include the board mounting portions 332. In contrast, in terms of firmly fixing the terminal assembly 30 to the circuit board 40, the reinforcing member 33 is only required to include the board mounting portions 332, and may not necessarily include the mounting reinforcing portions 333.

### Second Embodiment

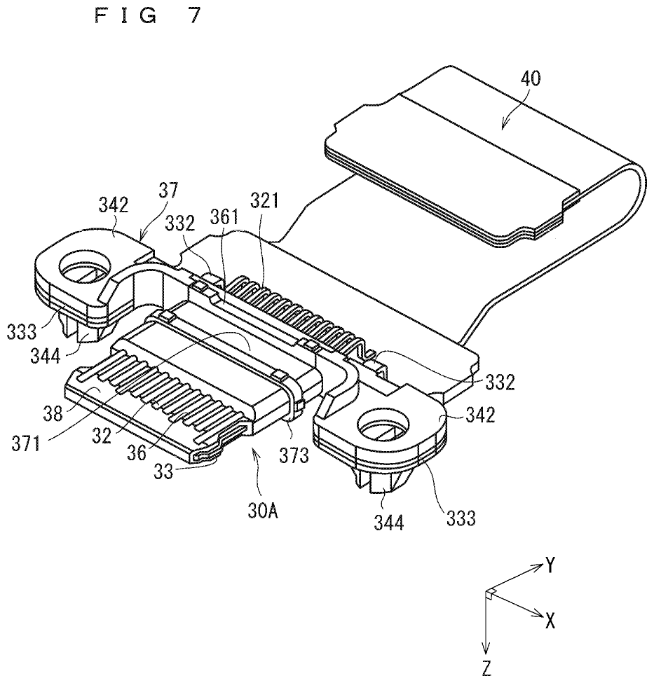

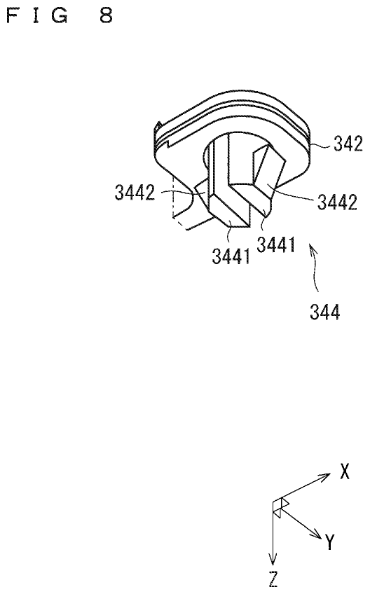

The electronic apparatus 1 according to a second embodiment has a similar configuration to the electronic apparatus 1 according to the first embodiment. In the second embodiment, however, the electronic apparatus 1 includes a terminal assembly 30A in place of the terminal assembly 30. FIG. 7 is a perspective view schematically illustrating one example of a configuration of a portion of the electronic apparatus 1. The terminal assembly 30A has a similar configuration to the terminal assembly 30 except for a structure to fix the terminal assembly 30A to the housing 10. In the terminal assembly 30A, the housing mounting portions 342 of the insulating member 37 have locking structures 344 locked to the housing 10. FIG. 8 is a perspective view schematically illustrating one example of a configuration of each of the locking structures 344 as obliquely viewed from the +Z side. As illustrated in FIG. 8, the locking structure 344 may include a pair of columnar portions 3441 and a pair of locking claws 3442.

The columnar portions 3441 each have a columnar shape protruding to the +Z side (i.e., the side of the housing 10), and face each other. For example, the columnar portions 3441 are disposed to face each other in the X-axis direction. The columnar portions 3441 are elastically deformable in a direction in which the distance between leading ends on the +Z side thereof changes (herein, the X-axis direction).

The locking claws 3442 are located on respective outer side surfaces of the columnar portions 3441. The locking claws 3442 protrude from the respective side surfaces of the columnar portions 3441, and the amount of protrusion decreases to the +Z side. That is to say, outer side surfaces of the locking claws 3442 are inclined towards the columnar portions 3441 to the +Z side.

The locking structures 344 of the housing mounting portions 342 are locked to locking structures located in the housing 10 (herein, the inner member 15). Specifically, the housing 10 has through holes through which the locking structures 344 pass. The locking structures 344 are inserted into the through holes of the housing 10 from leading ends thereof. At insertion, a peripheral portion of each of the through holes of the housing 10 comes into contact with the outer side surfaces of the locking claws 3442, and moves the locking structure 344 to the +Z side, so that the columnar portions 3441 elastically deform to be closer to each other upon receipt of a force from the peripheral portion. As the locking structure 344 is further moved to the +Z side, the locking claws 3442 pass through the through hole of the housing 10. The columnar portions 3441 are thereby elastically returned, and the locking claws 3442 are locked onto the peripheral portion of the through hole of the housing 10. The terminal assembly 30A can thereby be fixed to the housing 10. According to this configuration, a worker can easily fix the terminal assembly 30A to the housing 10.

### Third Embodiment

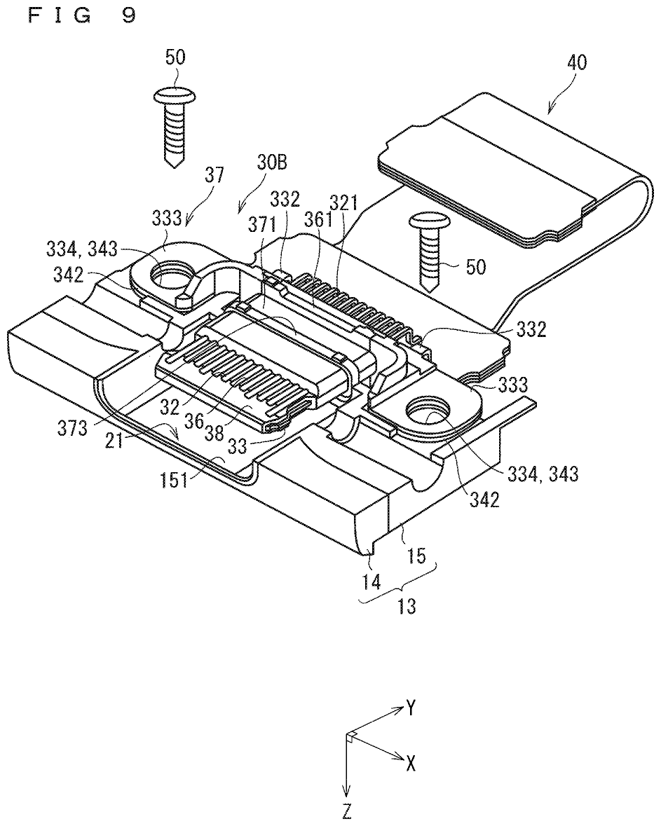

The electronic apparatus 1 according to a third embodiment has a similar configuration to the electronic apparatus 1 according to the first embodiment. In the third embodiment, however, the electronic apparatus 1 includes a terminal assembly 30B in place of the terminal assembly 30. FIG. 9 is a perspective view schematically illustrating one example of a configuration of a portion of the electronic apparatus 1. The terminal assembly 30B has a similar configuration to the terminal assembly 30 except for the housing mounting portions 342 of the insulating member 34.

In the terminal assembly 30B, at least portions of surfaces on the −Z side (surfaces opposite the inner member 15) of the mounting reinforcing portions 333 of the reinforcing member 33 are exposed from the insulating member 34. That is to say, the housing mounting portions 342 of the insulating member 34 do not cover at least portions of the surfaces on the −Z side of the mounting reinforcing portions 333 of the reinforcing member 33.

In addition, the reinforcing member 33 has conductivity. In the terminal assembly 30B as described above, a fixed potential (ground potential) may be applied to the reinforcing member 33. In other words, the reinforcing member 33 may be connected to a conductor for grounding. For example, the fastening members 50 and the housing 10 (the inner member 15) may have conductivity. As head portions (e.g., screw heads) of the fastening members 50 are in contact with the surfaces on the −Z side of the mounting reinforcing portions 333 of the reinforcing member 33, and columnar portions of the fastening members 50 are in contact with the inner member 15, the inner member 15 and the reinforcing member 33 are electrically connected to each other through the fastening members 50. In a case where a ground substrate is located inside the electronic apparatus 1, the inner member 15 may electrically be connected to the ground substrate. Alternatively, in a case where the back cover 12 has conductivity, the inner member 15 may electrically be connected to the back cover 12. The reinforcing member 33 can thereby be grounded.

The reinforcing member 33 (specifically, the main plate portion 331) can function as an electromagnetic shield between the terminals 31 and 32. The degree of the influence of an electromagnetic noise generated by a signal flowing through one of the terminals 31 and 32 on the other one of the terminals 31 and 32 can thereby be reduced.

The reinforcing member 33 can function as the electromagnetic shield in a configuration in which the terminals 31 are omitted from the terminal assembly 30B. In this case, the reinforcing member 33 shields against a disturbance noise propagated from the −Z side to the reinforcing member 33, and thus the degree of the influence of the disturbance noise on the terminals 32 can be reduced. Similarly, in a configuration in which the terminals 32 are omitted, the degree of the influence of a disturbance noise propagated from the +Z side on the terminals 31 can be reduced.

### Fourth Embodiment

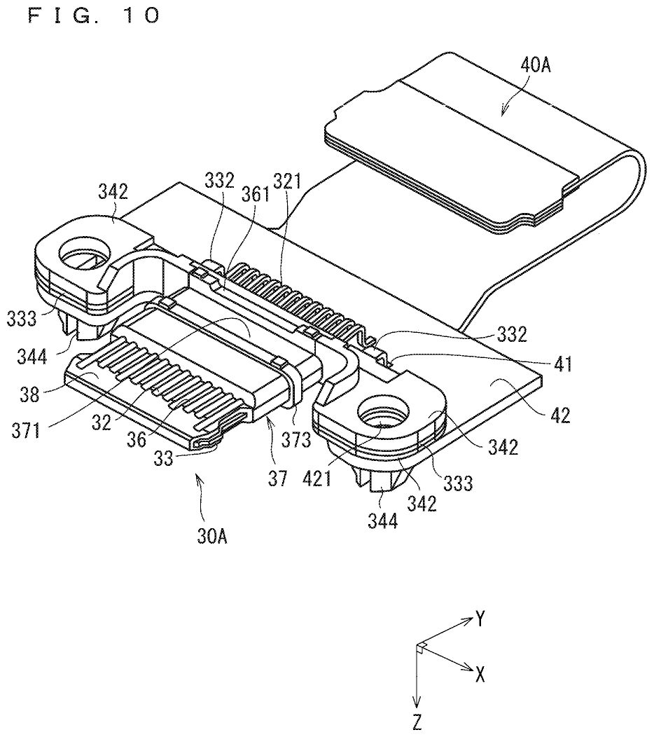

The electronic apparatus 1 according to a fourth embodiment has a similar configuration to the electronic apparatus 1 according to the second embodiment. In the fourth embodiment, however, the electronic apparatus 1 includes a circuit board 40A in place of the circuit board 40. FIG. 10 is a perspective view schematically illustrating one example of a configuration of a portion of the electronic apparatus 1. The circuit board 40A is similar to the circuit board 40, but a portion of the circuit board 40A is fixed to the housing mounting portions 342 of the terminal assembly 30A. For example, the circuit board 40A has a connection board 42 to which the terminals 31 and 32 are connected. The connection board 42 has a substantially U shape in plan view. The terminals 31 and 32 are connected to the connection board 42 in the middle of the substantially U shape. Opposite ends of the substantially U shape of the connection board 42 protrude to the −Y side, and are fixed to the respective housing mounting portions 342. For example, through holes 421 through which the locking structures 344 of the housing mounting portions 342 pass are formed in the opposite ends of the connection board 42.

The locking structures 344 of the housing mounting portions 342 pass through the through holes 421 of the circuit board 40A and the through holes of the housing 10, and the locking claws 3442 are locked onto the peripheral portions of the through holes of the housing 10. That is to say, the circuit board 40A is sandwiched between the housing mounting portions 342 and the housing 10. According to this configuration, the terminal assembly 30A, the circuit board 40A, and the housing 10 can be fixed together at the same location.

In the above-mentioned example, the terminal assembly 30A is fixed to the circuit board 40A by both the board mounting portions 332 of the reinforcing member 33 and the housing mounting portions 342 of the insulating member 34. Thus, the terminal assembly 30A can more firmly be fixed to the circuit board 40A. If the housing mounting portions 342 have a sufficient fixing force, however, the reinforcing member 33 may not necessarily include the board mounting portions 332.

In the above-mentioned example, the terminal assembly 30A and the circuit board 40A are fixed to the housing 10 by the locking structures 344 of the terminal assembly 30A. However, the terminal assembly 30 can be used in place of the terminal assembly 30A. That is to say, the terminal assembly 30, the circuit board 40A, and the housing 10 may be fixed to one another by the fastening members 50 in place of the locking structures 344. More specifically, a portion of the circuit board 40A may be disposed between the housing mounting portions 342 of the terminal assembly 30 and the housing 10 so that the through holes 421 of the circuit board 40A overlap the mounting holes 343 of the housing mounting portions 342 and the mounting holes 334 of the mounting reinforcing portions 333, and the terminal assembly 30 may be fixed to the housing 10 together with the circuit board 40A through fastening by the fastening members 50.

As described above, the circuit board 40A is fixed to the housing 10 using the housing mounting portions 342 of the terminal assembly 30 reinforced by the mounting reinforcing portions 333 of the reinforcing member 33. Thus, the circuit board 40A can more firmly be fixed to the terminal assembly 30 and the housing 10.

### Fifth Embodiment

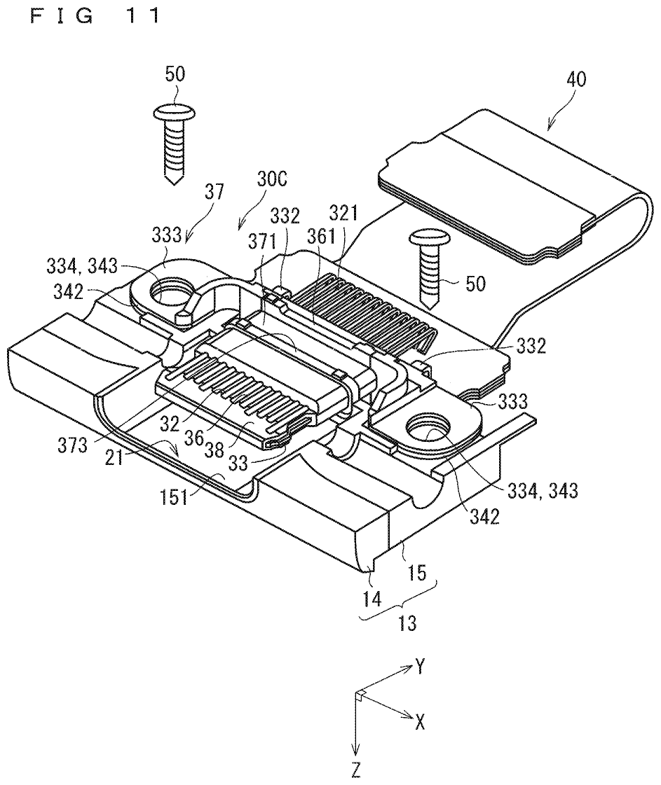

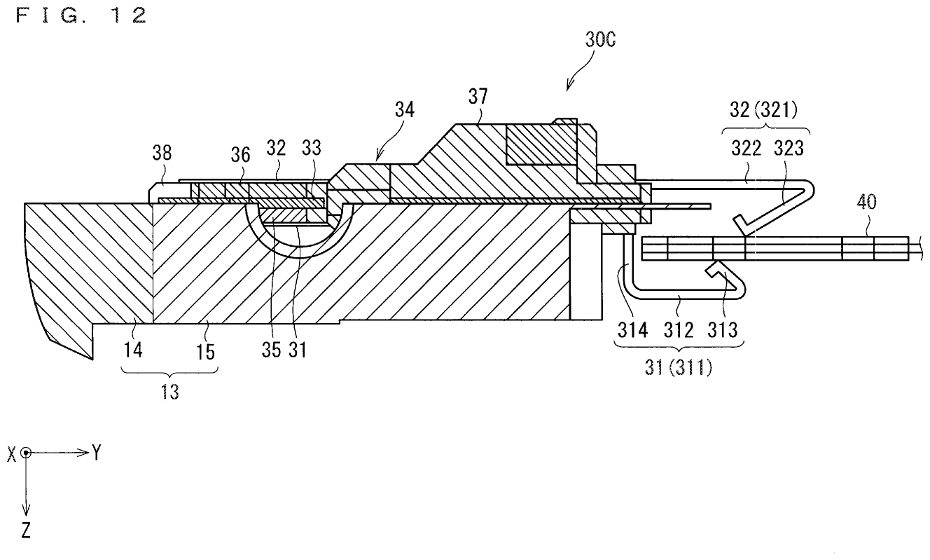

The electronic apparatus 1 according to a fifth embodiment has a similar configuration to the electronic apparatus 1 according to the third embodiment. In the fifth embodiment, however, the electronic apparatus 1 includes a terminal assembly 30C in place of the terminal assembly 30B. FIG. 11 is a perspective view schematically illustrating one example of a configuration of a portion of the electronic apparatus 1, and FIG. 12 is a side view schematically illustrating one example of the configuration of the portion of the electronic apparatus 1. The terminal assembly 30C has a similar configuration to the terminal assembly 30B except for the shapes of the terminals 31 and 32. The housing mounting portions 342 of the terminal assembly 30C do not cover the surfaces on the −Z side of the mounting reinforcing portions 333 of the reinforcing member 33 in FIG. 11, but may cover the surfaces as in the terminal assembly 30A. In the terminal assembly 30C, the ends 321 of the terminals 32 on the +Y side have elastic structures (e.g., leaf spring shapes) pressing the circuit board 40 in the thickness direction thereof (herein, the Z-axis direction). As a more specific example, the ends 321 have leaf spring shapes bent into substantially V shapes as viewed along the X-axis direction. For example, the ends 321 each include a portion 322 extending along the Y-axis direction and a portion 323 bent from an end of the portion 322 on the +Y side and obliquely extending to the −Y side and to the +Z side. These portions form the V shape. As illustrated in FIG. 12, a leading end of the portion 323 may be bent to the −Z side. Each of the ends 321 of the terminals 32 may come into contact with the connection pad on the surface of the circuit board 40 on the −Z side in a bending portion at the leading end of the portion 323. According to this configuration, wear of the connection pad on the circuit board 40 can be reduced compared with a configuration in which each of the ends 321 comes into contact with the connection pad in a corner portion at the leading end.

The ends 321 of the terminals 32 press, using an elastic force, the circuit board 40 to the +Z side at points of contact on the surface of the circuit board 40 on the −Z side. According to this configuration, even if the circuit board 40 is displaced in the Z-axis direction, for example, the ends 321 can elastically deform in accordance with the displacement to maintain electrical connections between the ends 321 and the connection pad on the circuit board 40.

As with the terminals 32, the ends 311 of the terminals 31 on the +Y side may also have the elastic structures (e.g., the leaf spring shapes) pressing the circuit board 40. As illustrated in FIG. 12, the ends 311 may have the leaf spring shapes in a space on the opposite side (+Z side) of the ends 321 of the terminals 32 with respect to the circuit board 40. In this case, the ends 311 of the terminals 31 come into contact with a connection pad located on the surface of the circuit board 40 on the +Z side on the opposite side of the terminals 32. The terminals 31 press the circuit board 40 to the −Z side at points of contact on the surface of the circuit board 40 on the +Z side. According to this configuration, the ends 311 of the terminal 31 and the ends 321 of the terminals 32 can sandwich the circuit board 40 in the Z-axis direction.

In the example of FIG. 12, the ends 311 of the terminals 31 each include a portion 314 extending in the Z-axis direction and crossing an end of the circuit board 40 on the −Y side, a portion 312 bent from an end of the portion 314 on the +Z side, and extending along the Y-axis direction in the space on the +Z side with respect to the circuit board 40, and a portion 313 bent from an end of the portion 312 on the +Y side, and obliquely extending to the −Y side and to the −Z side. The portions 312 and 313 have a leaf spring shape of a substantially V shape. As illustrated in FIG. 12, a leading end of the portion 313 may be bent to the +Z side. Each of the ends 311 of the terminals 31 may come into contact with the connection pad on the surface of the circuit board 40 on the −Z side in a bending portion at the leading end of the portion 313. This can reduce wear of the connection pad on the circuit board 40.

Leading ends of the ends 311 press the circuit board 40 to the −Z side using an elastic force. According to this configuration, even if the circuit board 40 is displaced in the Z-axis direction, for example, the ends 311 can elastically deform in accordance with the displacement to maintain electrical connections between the ends 311 and the connection pad on the circuit board 40. As the ends 311 of the terminals 31 and the ends 321 of the terminals 32 press the circuit board 40 from opposite sides in the Z-axis direction, the circuit board 40 can be sandwiched.

In the example of FIG. 12, the points of contact between the terminals 31 and the circuit board 40 are located on the −Y side of the points of contact between the terminals 32 and the circuit board 40. The locations of these points of contact, however, may substantially the same, or may be reversed in the Y-axis direction.

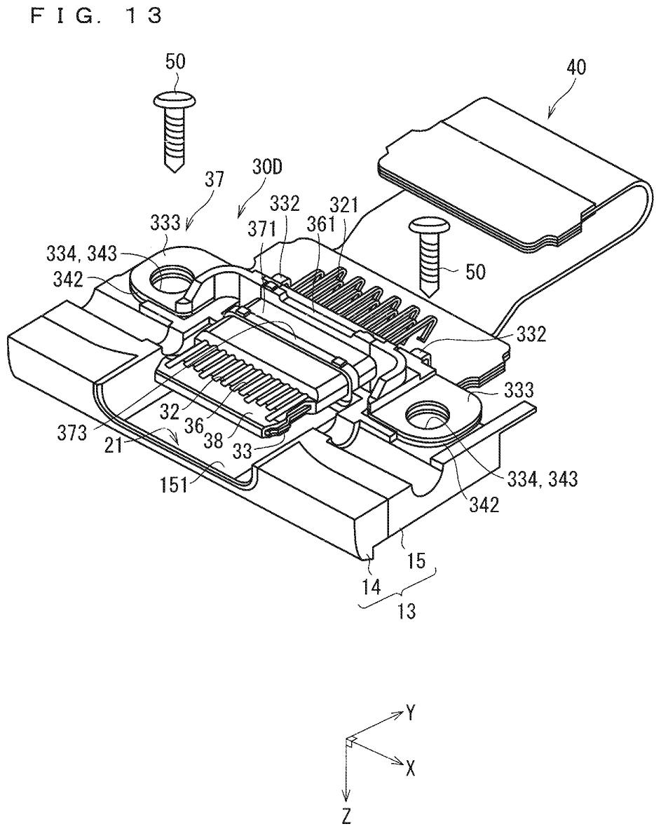

FIG. 13 is a perspective view schematically illustrating one example of another configuration of the portion of the electronic apparatus 1. The electronic apparatus 1 includes a terminal assembly 30D in place of the terminal assembly 30. The terminal assembly 30D has a similar configuration to the terminal assembly 30C except for the shapes of the terminals 31 and 32.

In the terminal assembly 30D, locations of contact (locations of points of contact) of the terminals 32 with the circuit board 40 vary in the Y-axis direction. That is to say, a location of a point of contact of one of the terminals 32 is offset from a location of a point of contact of at least another one of the terminals 32 in the Y-axis direction. In the example of FIG. 12, locations of points of contact of odd-numbered terminals of the terminals 32 are offset in the same direction from locations of points of contact of even-numbered terminals of the terminals 32 in the Y-axis direction. For example, assume that one of the terminals 32 located at an end on the −X side is a first terminal, and the number increases to the +X side. In the example of FIG. 12, any locations of the points of contact of the odd-numbered terminals of the terminals 32 are located on one side in the Y-axis direction (herein, on the −Y side) of the locations of the points of contact of the even-numbered terminals of the terminals 32. In other words, the locations of the points of contact of the terminals 32 are staggered.

In the example of FIG. 12, the length (the length along the Y-axis direction) of protrusion of each of the ends 321 of the terminals 32 from the insulating member 34 varies among the terminals 32. In the example of FIG. 12, the ends 321 of the odd-numbered terminals have shorter length of protrusion than the ends 321 of the even-numbered terminals. Acute angles of substantially V shapes of the ends 321 of the terminals 32 are approximately the same. According to this configuration, any locations of the points of contact of the odd-numbered terminals of the terminals 32 are located on the −Y side of the locations of the points of contact of the even-numbered terminals of the terminals 32.

As with the terminals 32, a location of a point of contact of one of the terminals 31 may be offset from a location of a point of contact of at least another one of the terminals 31 in the Y-axis direction.

As described above, according to the terminal assembly 30D, a location of a point of contact of at least one of the terminals 32 is offset from a location of a point of contact of another one of the terminals 32 in the Y-axis direction. Stress concentration of the terminals 32 on the circuit board 40 can thereby be reduced. When the locations of the points of contact of the terminals 32 are staggered, the locations of the points of contact can be dispersed efficiently, and thus stress concentration on the circuit board 40 can effectively be reduced. The same applies to the terminals 31.

The fifth embodiment is not necessarily premised on the first to fourth embodiments. For example, a metal shell fixed to the terminal assembly 30 may be located, and fixed to the circuit board 40.

While the terminal assembly and the electronic apparatus have been described in detail above, the foregoing description is in all aspects illustrative and does not restrict the present disclosure. The above-mentioned embodiments and various modifications are applicable in combination unless any contradiction occurs. It is understood that numerous modifications not having been exemplified can be devised without departing from the scope of the disclosure.

What is claimed is:

1. A terminal assembly to be connected to a mating connector at a receptacle formed in a housing of an electronic apparatus, the terminal assembly comprising:
at least one terminal extending in a longitudinal direction;
an insulating member including:
a holder holding the at least one terminal; and
a housing mounting portion extending from the holder in a direction transverse to the longitudinal direction, and fixed to the housing inside the housing; and
a reinforcing member including a mounting reinforcing portion reinforcing the housing mounting portion.

2. The terminal assembly according to claim 1, wherein
stiffness of the mounting reinforcing portion is higher than stiffness of the housing mounting portion.

3. The terminal assembly according to claim 1, wherein
the housing mounting portion and the mounting reinforcing portion each include a mounting hole through which a fastening member to pass.

4. The terminal assembly according to claim 1, wherein
the housing mounting portion includes a locking structure to be locked to the housing.

5. The terminal assembly according to claim 1, wherein
the reinforcing member further includes a main plate portion being opposite the at least one terminal, and
a portion of the insulating member is interposed between the at least one terminal and the main plate portion.

6. The terminal assembly according to claim 5, wherein
the reinforcing member includes conductivity, and
at least portion of one surface of the mounting reinforcing portion is exposed from the insulating member.

7. The terminal assembly according to claim 6, wherein
the at least portion of the mounting reinforcing portion is connected to a conductor for grounding.

8. The terminal assembly according to claim 5, wherein
the insulating member covers the main plate portion from opposite sides in a thickness direction of the main plate portion.

9. The terminal assembly according to claim 1, wherein
the reinforcing member is made of metal, resin, or ceramic.

10. An electronic apparatus comprising:
the terminal assembly according to claim 1;
the housing; and
a circuit board located inside the housing, and connected to the at least one terminal, wherein
the reinforcing member further includes at least one board mounting portion, and
the at least one board mounting portion is fixed to the circuit board.

11. The electronic apparatus according to claim 10, wherein
the circuit board includes a hole, and
the at least one board mounting portion is inserted into the hole of the circuit board.

12. The electronic apparatus according to claim 11, wherein
the at least one board mounting portion is fixed to the circuit board using an adhesive or solder at a location of insertion into the hole.

13. The electronic apparatus according to claim 10, wherein
the at least one board mounting portion comprises a pair of board mounting portions,
the reinforcing member further includes an extending portion,
the extending portion extends from the mounting reinforcing portion in the direction transverse to the longitudinal direction, and crosses the at least one terminal, and
the board mounting portions are located opposite each other with respect to the at least one terminal, and protrude from the extending portion along the longitudinal direction to be fixed to the circuit board.

14. An electronic apparatus comprising:
the terminal assembly according to claim 1;
the housing; and
a circuit board located inside the housing, and connected to the at least one terminal, wherein
the housing mounting portion of the insulating member is fixed to the housing together with the circuit board.

15. An electronic apparatus comprising:
the terminal assembly according to claim 1; and
a guide member made of resin, and forming the receptacle.

16. The electronic apparatus according to claim 15, wherein
the guide member is formed by the housing.

17. The electronic apparatus according to claim 16, wherein
the guide member includes:
an inner peripheral surface forming the receptacle; and
a first protrusion protruding from the inner peripheral surface towards the terminal assembly,
the holder includes a second protrusion protruding towards the guide member at a location opposite the first protrusion, and
an end surface of the first protrusion on an entrance side of the receptacle is located on the entrance side with respect to an end surface of the second protrusion on the entrance side.

18. An electronic apparatus comprising:
the terminal assembly according to claim 1;
the housing; and
a circuit board located inside the housing, and connected to the at least one terminal, wherein
the at least one terminal includes an elastic structure pressing the circuit board in a thickness direction of the circuit board at a point of contact with the circuit board.

19. The electronic apparatus according to claim 18, wherein
the at least one terminal comprises a first terminal and a second terminal, and
a location of a point of contact of the first terminal with the circuit board in the longitudinal direction differs from a location of a point of contact of the second terminal with the circuit board in the longitudinal direction.

20. The electronic apparatus according to claim 18, wherein
the at least one terminal comprises a plurality of terminals arranged side by side, and
any locations of points of contact of even-numbered terminals of the plurality of terminals with the circuit board in the longitudinal direction are on one side in the longitudinal direction of locations of points of contact of odd-numbered terminals of the plurality of terminals with the circuit board in the longitudinal direction.
